(19) United States
(12) Patent Application Publication
(10) Pub. No.: US 2021/0065212 A1
(43) Pub. Date: Mar. 4, 2021

(54) DATE GENERATION APPARATUS, CONTROL METHOD, AND PROGRAM

(71) Applicant: NEC Corporation, Tokyo (JP)

(72) Inventors: Kensuke MATSUKI, Tokyo (JP); Masahito SAKAI, Tokyo (JP)

(73) Assignee: NEC Corporation, Tokyo (JP)

(21) Appl. No.: 17/002,184

(22) Filed: Aug. 25, 2020

(30) Foreign Application Priority Data
Aug. 26, 2019 (JP) 2019-153750

(51) Int. Cl. G06Q 30/00; G06F 16/2457; G06F 16/29; G06Q 10/08; G06Q 50/04; G06Q 30/02

(52) U.S. Cl. CPC G06Q 30/0185; G06F 16/24575; G06Q 30/0205; G06Q 10/087; G06Q 50/04; G06F 16/29

(57) ABSTRACT

A date generation apparatus 2000 acquires the date information 20 regarding the target product 10 and the rule condition indicating the condition regarding the generation rule 40. The generation rule 40 is a rule for generating a character string 30 to be attached to the target product 10 from the date information 20. The date generation apparatus 2000 acquires the generation rule 40 corresponding to the rule condition. Then, the date generation apparatus 2000 uses the generation rule 40 to generate the character string 30 from the date information 20.

This application is based on Japanese patent application NO. 2019-153750, the content of which is incorporated hereinto by reference.

### BACKGROUND

### Technical Field

The present invention relates to a technique of attaching a date to a product.

### Related Art

In many cases, a product is provided with a date indicating the manufacturing date, the expiration date, or the like. Therefore, a technique has been developed in which a date indicating a manufacturing date or the like is attached to a product. For example, Japanese Unexamined Patent Publication No. 2011-011525 discloses a technique of computing a deadline date of a product by adding the deadline of the product to the manufacturing date of the product and issuing a label indicating the deadline date.

### SUMMARY

The present inventor has found that what kind of date (type and format of date) is to be attached to a product may differ depending on the case. In this regard, in Japanese Unexamined Patent Publication No. 2011-011525, a method of determining the date to be attached to the label is fixed.

The present invention has been made in view of the above problems, and one of its objects is to provide a technique for appropriately determining a date to be attached to a product.

In one embodiment, there is provided a date generation apparatus including 1) an acquisition unit that acquires date information about a target product, and a rule condition indicating a condition regarding a generation rule for generating a character string to be attached to the target product from the date information, and 2) a generation unit that generates the character string for the target product, using the generation rule corresponding to the acquired rule condition, from the acquired date information.

The date information and the character string represent either the manufacturing date or the expiration date of the target product.

In another embodiment, there is provided a control method executed by a computer. The control method includes 1) acquiring date information about a target product, and a rule condition indicating a condition regarding a generation rule for generating a character string to be attached to the target product from the date information, and 2) generating the character string for the target product, using the generation rule corresponding to the acquired rule condition, from the acquired date information.

The date information and the character string represent either the manufacturing date or the expiration date of the target product.

According to the present invention, there is provided a technique for appropriately determining the date to be attached to a product.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a diagram for explaining an overview of a date generation apparatus of Example Embodiment 1.

FIG. 2 is a diagram illustrating a functional configuration of the date generation apparatus according to Example Embodiment 1.

FIG. 3 is a diagram illustrating a computer to implement the date generation apparatus.

FIG. 4 is a flowchart illustrating the flow of a process executed by the date generation apparatus according to Example Embodiment 1.

FIG. 5 is a diagram illustrating a usage environment of the date generation apparatus.

FIG. 6 is a diagram illustrating a configuration of rule information in a table format.

FIG. 7 is a diagram illustrating a configuration of rule information in a table format.

FIG. 8 is a diagram illustrating a configuration of rule information in a table format.

FIG. 9 is a diagram illustrating rule information.

### DETAILED DESCRIPTION

The invention will be now described herein with reference to illustrative embodiments. Those skilled in the art will recognize that many alternative embodiments can be accomplished using the teachings of the present invention and that the invention is not limited to the embodiments illustrated for explanatory purposes.

Hereinafter, embodiments of the present invention will be described with reference to the drawings. In all the drawings, the same components are denoted by the same reference numerals, and the description thereof will not appropriately be repeated. In each of the block diagrams, unless otherwise specified, each block represents a functional unit configuration, instead of a hardware unit configuration.

### Example Embodiment 1

### Overview

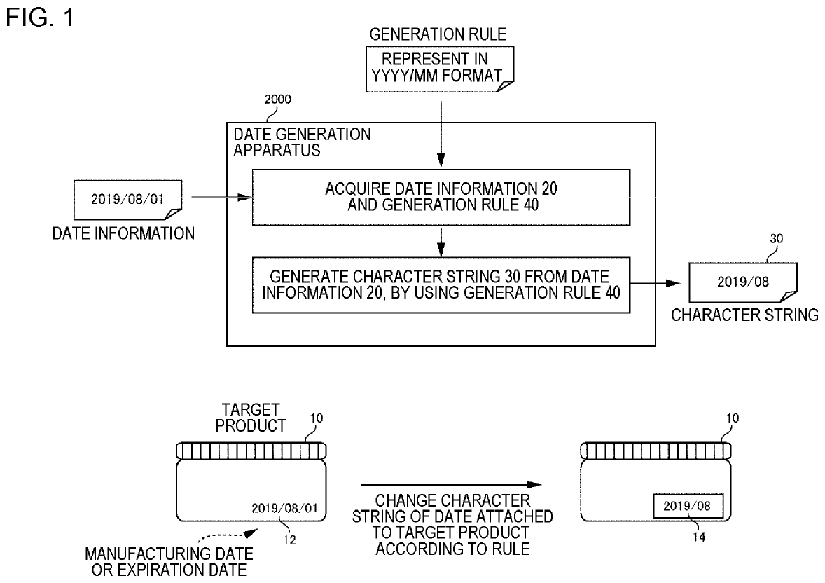

FIG. 1 is a diagram for explaining an overview of the date generation apparatus 2000 of the present example embodiment. Note that, FIG. 1 illustrates an example for facilitating understanding of the date generation apparatus 2000, and the functions of the date generation apparatus 2000 are not limited to those shown in FIG. 1.

The date generation apparatus 2000 is used in a situation in which a date related to a product such as a manufacturing date or an expiration date of the product is attached to the product. As a method of attaching a date to a product, various methods such as a method of sticking a label on which a date is printed on the exterior of a product and a method of directly printing a date on the exterior of a product can be adopted.

Here, there may be various variations in the date to be attached to the product. For example, it is assumed that there is a product manufactured at 13:00 on Aug. 1, 2019. When attaching a manufacturing date to this product, various ways to represent the manufacturing date, such as “2019/08/01 13:00’”, “2019/08/01”, or “08/01, 2019”. can be adopted. It is also possible that information indicating the product life is provided in addition to the manufacturing date, and the expiration date calculated based on these types of information is attached to the product.

Therefore, the date generation apparatus 2000 generates a character string representing the date to be attached to the product, based on a predetermined rule. To do so, the date generation apparatus 2000 first acquires the date information 20 for the target product 10 that is the target product to which the date is attached. The date information 20 is information representing the date related to the target product 10. For example, the date information 20 represents the manufacturing date or the expiration date of the target product 10. Note that, the expiration date represents a deadline for completing the use and consumption of the target product 10. Therefore, the concept of expiration date includes a period of consumption, a best-before date, or the like.

In addition, the date generation apparatus 2000 acquires the generation rule 40. The generation rule 40 is a rule for generating the character string 30 from the date information 20. The generated character string 30 is a character string of a date to be attached to the target product 10. For example, the generation rule 40 is a rule such as “represent a manufacturing date in a format <YYYY/MM/DD>”, “calculate an expiration date from the manufacturing date and product life, and represent the expiration date in a format <YYYY/MM>”, or the like. Here, YYYY is four characters representing the year, MM is two characters representing the month, and DD is two characters representing the day. Note that, the details of the generation rule 40 will be described later.

In the example of FIG. 1, the date character string to be attached to the target product 10 is changed. For example, when the target product 10 is exported, the date character string to be attached to the target product 10 may be changed when the export country and the importing country have different requirements for attaching the manufacturing date and the like to the product.

To meet the requirements, the date generation apparatus 2000 acquires the first date character string 12 as the date information 20, and uses the generation rule 40 to generate the character string 30 from the date information 20. Then, the character string 30 generated by the date generation apparatus 2000 is attached to the target product 10 as the second date character string 14.

Note that, a usage the date generation apparatus 2000 is not necessarily limited to changing the date character string attached to the target product 10. For example, the target product 10 before the date generation apparatus 2000 is used may not have the date character string attached thereto. Various usages of the date generation apparatus 2000 will be described later.

Hereinafter, the present example embodiment will be described in more detail.

### Example of Functional Configuration

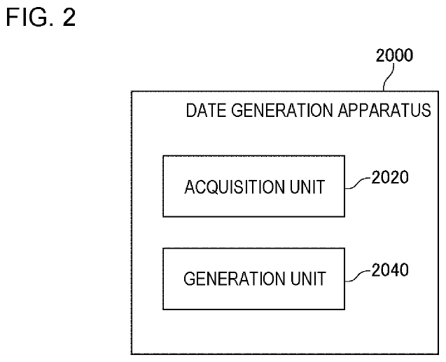

FIG. 2 is a diagram illustrating a functional configuration of the date generation apparatus 2000 according to Example Embodiment 1. The date generation apparatus 2000 includes an acquisition unit 2020 and a generation unit 2040. The acquisition unit 2020 acquires the date information 20 on the target product 10. Further, the acquisition unit 2020 acquires the generation rule 40 for converting the date information 20 into the character string 30. The generation unit 2040 uses the generation rule 40 to generate the character string 30 from the date information 20.

### Example of Hardware Configuration of Date Generation apparatus 2000

Each functional configuration unit of the date generation apparatus 2000 may be achieved by hardware (for example, hard-wired electronic circuits) that achieves each functional configuration unit, or a combination of hardware and software (for example, a combination of an electronic circuit, a program for controlling the electronic circuit, and the like). Hereinafter, a case where each functional configuration unit of the date generation apparatus 2000 is achieved by a combination of hardware and software will be further described.

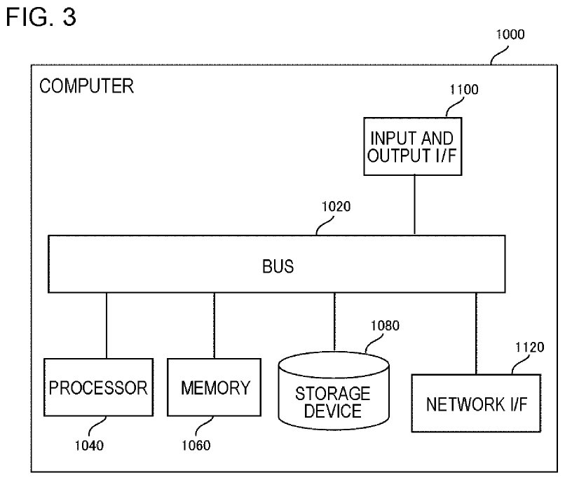

FIG. 3 is a diagram illustrating a computer 1000 to implement the date generation apparatus 2000. The computer 1000 is any computer. For example, the computer 1000 is a portable computer such as a smartphone or a tablet terminal. In addition, for example, the computer 1000 may be a stationary computer such as a personal computer (PC) or a server machine.

The computer 1000 may be a dedicated computer designed to implement the date generation apparatus 2000 or may be a general purpose computer. In the latter case, for example, by installing a predetermined application in the computer 1000, the functions of the date generation apparatus 2000 are implemented in the computer 1000. The application is configured by a program for implementing the functional configuration unit of the date generation apparatus 2000.

The computer 1000 includes a bus 1020, a processor 1040, a memory 1060, a storage device 1080, an input and output interface 1100, and a network interface 1120. The bus 1020 is a data transmission path through which the processor 1040, the memory 1060, the storage device 1080, the input and output interface 1100, and the network interface 1120 mutually transmit and receive data. However, a method of connecting the processor 1040 and the like to each other is not limited to bus connection.

The processor 1040 is various processors such as a central processing unit (CPU), a graphics processing unit (GPU), a field-programmable gate array (FPGA), or the like. The memory 1060 is a main storage achieved by using a random access memory (RAM) or the like. The storage device 1080 is an auxiliary storage achieved by using a hard disk, a solid state drive (SSD), a memory card, a read only memory (ROM), or the like.

The input and output interface 1100 is an interface for connecting the computer 1000 and an input/output device. For example, an input apparatus such as a keyboard and an output apparatus such as a display apparatus are connected to the input and output interface 1100.

The network interface 1120 is an interface for connecting the computer 1000 to a communication network. The communication network is, for example, a local area network (LAN) or a wide area network (WAN). For example, am analysis apparatus and a user terminal are communicably connected via the network interface 1120.

The storage device 1080 stores program modules that achieve functional configuration units of the date generation apparatus 2000 (program modules that achieve the above-described application). The processor 1040 reads these respective program modules into the memory 1060 and executes them, thereby achieving the respective functions corresponding to the respective program modules.

### Process Flow

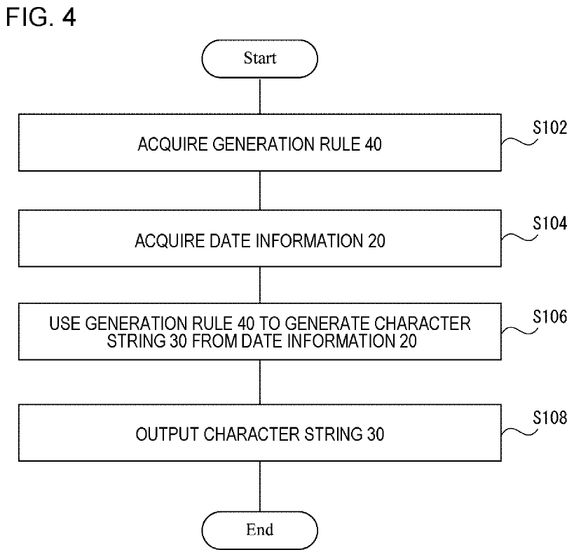

FIG. 4 is a flowchart illustrating the flow of a process executed by the date generation apparatus 2000 according to Example Embodiment 1. The acquisition unit 2020 acquires the generation rule 40 (S102). The acquisition unit 2020 acquires the date information 20 for the target product 10 (S104). The generation unit 2040 uses the generation rule 40 to generate the character string 30 from the date information 20 (S106). The generation unit 2040 outputs the generated character string 30 (S108).

The flow of the process executed by the date generation apparatus 2000 is not limited to the flow illustrated in FIG. 4. For example, when the information to be acquired as the date information 20 can be determined without referring to the generation rule 40, the acquisition of the date information 20 may be performed in parallel with the acquisition of the generation rule 40, or may be performed before the acquisition of the generation rule 40.

### Example of Usage Environment of Date Generation apparatus 2000

In order to make the following description easy to understand, a more specific usage environment of the date generation apparatus 2000 will be illustrated. However, the usage environment of the date generation apparatus 2000 is not limited to the one described here.

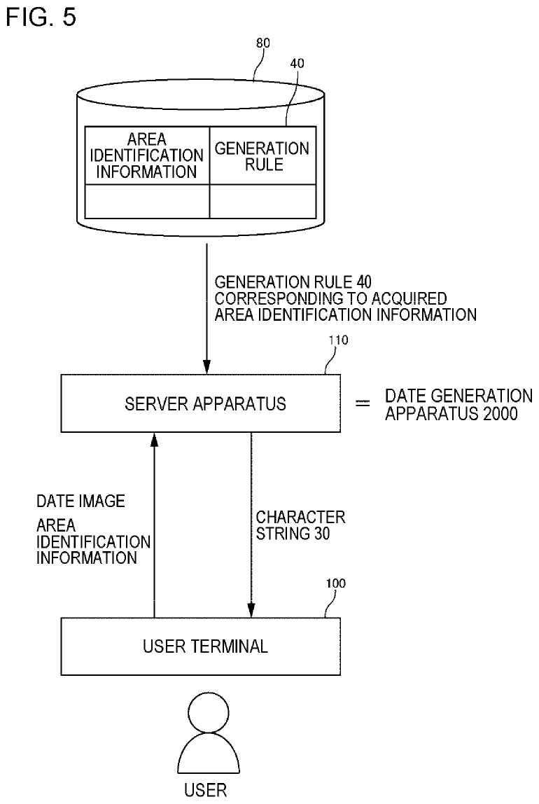

FIG. 5 is a diagram illustrating a usage environment of the date generation apparatus 2000. In this example, the date generation apparatus 2000 is implemented as the server apparatus 110. A user accesses the server apparatus 110 using a user terminal 100, and uses the server apparatus 110 (that is, the date generation apparatus 2000). The user terminal 100 is any terminal used by a user, and is, for example, a mobile terminal such as a tablet terminal or a smartphone.

For example, the date generation apparatus 2000 is used in repacking the target product 10. The repacking work referred to herein is for the company that has purchased the target product 10 to stick a label on the target product 10 or to change the exterior of the target product 10, for sale (retail or wholesale). Further, such a repacking work may include a work of changing the type or format of the date to be attached to the target product 10.

For example, what kind of date is to be attached to a product and in what format may be different for each area such as a country or a state. For example, it is conceivable that, “attaching the manufacturing date in the format <YYYY/MM/DD>” is required in Country A, “attaching the manufacturing date in the format <YYYY.MM>” is required in Country B, and “attaching the expiration date in the format of <MM/DD, YYYY>” is required in Country C. Therefore, when exporting the target product 10, it is necessary to change the date character string attached to the target product 10 as required by the country of export destination.

Therefore, for example, in each country in which the target product 10 is imported, the repacking work using the date generation apparatus 2000 is performed at an appropriate timing (for example, before delivering the target product 10 to the dealer in that country). For example, when the target product 10 is exported from Country A to Country B, a worker who performs a repacking work in Country B changes the date character string to be attached to the target product 10 from a format of “representing a manufacturing date in <YYYY/MM/DD>” to a format of “representing a manufacturing date in <YYYY.MM>”. The method will be specifically illustrated below.

First, the worker images the first date character string 12 attached to the target product 10 with a camera provided in the user terminal 100. As a result, a captured image (hereinafter, a date image) including the first date character string 12 attached to the target product 10 is generated. The user terminal 100 transmits this date image to the server apparatus 110. The server apparatus 110 performs a character recognition process on the received date image. As a result, date information 20 about the target product 10 is obtained.

In addition, the user terminal 100 transmits information (hereinafter, area identification information) that identifies an area called Country B to the server apparatus 110. Here, in the present example, the generation rule 40 is stored in a storage apparatus in association with the area identification information. Hereinafter, the storage apparatus in which the generation rule 40 is stored is referred to as a generation rule storage apparatus 80. The server apparatus 110 acquires the generation rule 40 (that is, the generation rule 40 for country B) stored in association with the received area identification information, and uses the generation rule 40 to generate the character string 30 from the date information 20. The server apparatus 110 transmits the character string 30 to the user terminal 100.

The worker browses the character string 30 received by the user terminal 100 by using a display of the user terminal 100. By doing so, the worker can recognize that a character string (second date character string 14) to be newly attached to the target product 10 is a character string represented by the character string 30. The worker sets the character string 30 in a printer for printing the character string on the label, and then prints on the label to be stick on the target product 10. Then, the worker sticks the label on the target product 10. By doing so, the date character string (character string 30) that matches the requirements in Country B can be attached to the target product 10 as the second date character string 14. Note that, as will be described later, the character string 30 may be automatically set in the printer.

Further, the date generation apparatus 2000 may be used for the checking work for checking whether or not the second date character string 14 attached to the target product 10 is correct. In this case, the worker first determines the second date character string 14 without using the date generation apparatus 2000. For example, the worker visually checks the first date character string 12 attached to the target product 10, and determines the second date character string 14 by referring to a method of converting the first date character string 12 to the second date character string 14 written in the work manual.

The worker adds the first date character string 12 determined in this way to the target product 10. Thereafter, the worker checks whether or not the second date character string 14 added to the target product 10 is correct by using the date generation apparatus 2000.

First, the worker uses the user terminal 100 to generate a date image of the first date character string 12 attached to the target product 10 before the repacking work. Further, the worker uses the user terminal 100 to generate the date image of the second date character string 14 attached to the target product 10 after the repacking work. The user terminal 100 transmits these two date images to the date generation apparatus 2000. Further, as described above, the area identification information is also transmitted from the user terminal 100 to the date generation apparatus 2000.

The date generation apparatus 2000 acquires the generation rule 40 corresponding to the received area identification information. The date generation apparatus 2000 determines the first date character string 12 (acquires the date information 20) by performing the character recognition process on the date image of the first date character string 12. The date generation apparatus 2000 uses the generation rule 40 to generate the character string 30 from the first date character string 12. The date generation apparatus 2000 determines the second date character string 14 by performing the character recognition process on the date image of the second date character string 14, and determines whether or not the determined second date character string 14 matches the generated character string 30. The date generation apparatus 2000 transmits the determination result to the user terminal 100. The worker can check whether or not the second date character string 14 attached to the target product 10 is correct by referring to this determination result with the user terminal 100.

For example, the checking work described herein is performed on the first one of the target products 10 included in the lot. Then, if it is checked using the date generation apparatus 2000 that the correct second date character string 14 is attached to the first one, the work of attaching the same second date character string 14 to the remaining target products 10 is performed. In this way, by performing the checking work on the first target product 10 and then attaching the same second date character string 14 to the remaining target products 10, it is possible to prevent the problem that erroneous second date character strings 14 are attached to many target products 10.

As described above, the usage environment of the date generation apparatus 2000 is not limited to the description herein. For example, the date generation apparatus 2000 may be implemented as the user terminal 100 instead of the server apparatus 110. In this case, each process executed by the server apparatus 110 in the above-described example is implemented by the user terminal 100.

### Acquisition of Generation Rule 40: S102

The acquisition unit 2020 acquires the generation rule 40 (S102). For example, the generation rule 40 is stored in advance in a storage apparatus (the above-mentioned generation rule storage apparatus 80) accessible from the date generation apparatus 2000. The acquisition unit 2020 acquires the generation rule 40 by accessing the generation rule storage apparatus 80.

Here, a plurality of generation rules 40 may be prepared. In this case, the acquisition unit 2020 acquires one generation rule 40 to be acquired, from the plurality of generation rules 40 stored in the generation rule storage apparatus 80.

There are various methods for the acquisition unit 2020 to identify the generation rule 40 to be acquired. For example, the acquisition unit 2020 receives a user operation that specifies the generation rule 40 to be acquired. In this case, the acquisition unit 2020 acquires the generation rule 40 specified by the user operation.

The method of determining the generation rule 40 to be acquired is not limited to the method based on the user operation. For example, the acquisition unit 2020 acquires a condition regarding the generation rule 40 to be acquired (hereinafter, rule condition) before acquiring the generation rule 40. In this case, the acquisition unit 2020 acquires the generation rule 40 corresponding to the rule condition. That is, the generation rule 40 to be acquired is determined by the rule condition.

As described above, by generating the character string 30 using the generation rule 40 corresponding to the acquired condition, it is possible to generate an appropriate character string 30 according to the situation. That is, it becomes possible to appropriately determine the date character string to be attached to the target product 10 according to the situation and attach the appropriate date character string to the target product 10.

Various rule conditions can be used. The rule conditions will be illustrated below.

### Case Where Area is Used as Rule Condition

As described above, the method of representing the date to be attached to a product may differ for each area such as a country or a state. In such a case, each generation rule 40 is stored in the generation rule storage apparatus 80 in association with the area identification information that identifies the area in which the generation rule 40 is to be used. For example, the area identification information indicates the name of the area (country name, local name, state name, prefecture name, or the like), the identification number assigned to the area, or the like. Further, the area identification information is not limited to the information that identifies an individual area, and may be information that identifies a group of areas (for example, a group of a plurality of countries or states). That is, the generation rule 40 for generating the character string 30 to be attached to the area of the group may be associated with the area group. Hereinafter, the information in which the generation rule 40 and the area identification information are associated with each other is referred to as rule information 50.

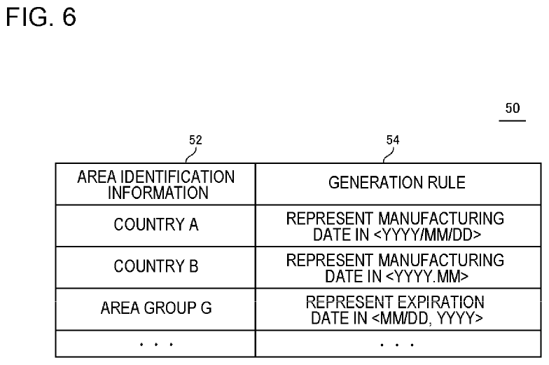

FIG. 6 is a diagram illustrating the configuration of the rule information 50 in a table format. The rule information 50 includes two fields: area identification information 52 and generation rule 54. The area identification information 52 indicates the area identification information described above. The generation rule 54 indicates the generation rule 40.

When the generation rule 40 is defined for each area, the acquisition unit 2020 first acquires area identification information as a rule condition. The area identification information to be acquired is, for example, identification information of an area where the target product 10 is sold, or identification of a group to which the area belongs. Further, the acquisition unit 2020 acquires the generation rule 40 by searching the generation rule storage apparatus 80 using the acquired area identification information. Specifically, the acquisition unit 2020 acquires the generation rule 40 indicated by the rule information 70, from the record in which the acquired area identification information is shown in the area identification information 52. By doing so, the acquisition unit 2020 acquires the generation rule 40 corresponding to the acquired area identification information (that is, the generation rule 40 corresponding to the acquired rule condition).

There are various methods by which the acquisition unit 2020 acquires the area identification information. For example, the acquisition unit 2020 acquires the area identification information specified by the user operation. The user operation of specifying the area identification information is performed on the user terminal 100 described above, for example.

In addition, for example, the area identification information may be stored in advance in a storage apparatus in association with the identification information of the user. The area identification information associated with the identification information of the user is, for example, identification information of the area where the user works. The acquisition unit 2020 acquires the identification information of the user and acquires the area identification information associated with the acquired identification information of the user. However, the area identification information corresponding to the identification information of the user may be acquired using the user terminal 100, and the acquired area identification information may be transmitted from the user terminal 100 to the server apparatus 110. Note that, various existing techniques can be used as the technique for acquiring the identification information of the user.

In addition, for example, the acquisition unit 2020 may acquire area identification information determined by position information such as global positioning system (GPS) coordinates. For example, this position information is position information obtained from the GPS sensor or the like of the user terminal 100. Note that, the process of converting position information such as GPS coordinates into area identification information may be performed by the date generation apparatus 2000, or may be performed by an apparatus other than the date generation apparatus 2000. In addition, an existing technique can be used for the technique to determine an area such as a country and a state from GPS coordinates.

### Case Where Product is Used as Rule Condition

The method of representing the date to be attached to a product may differ for each product. For example, it is conceivable that a product A is required to “attach the manufacturing date in the format <YYYY/MM/DD>”, a product B is required to “attach the manufacturing date in the format <YYYYMM>”, and a product C is required to “attach the expiration date in the format of <MM.DD, YYYY>”.

In such a case, each generation rule 40 is stored in the generation rule storage apparatus 80 in association with product identification information that determines a product for which the generation rule 40 is to be used. For example, the product identification information indicates the name of the product, the identification number assigned to the product, or the like. Further, the product identification information is not limited to the information that identifies individual products, and may be information that identifies a group of products (for example, milk, meat, or fish). That is, the group of products may be associated with the generation rule 40 for generating the character string 30 to be attached to the products of the group. Hereinafter, the information in which the generation rule 40 and the product identification information are associated with each other is referred to as rule information 60.

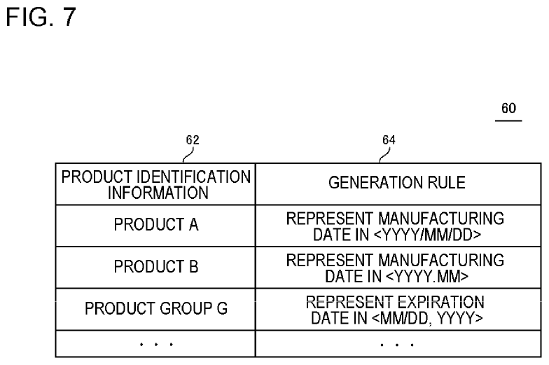

FIG. 7 is a diagram illustrating the configuration of the rule information 60 in a table format. The rule information 60 includes two fields: product identification information 62 and generation rule 64. The product identification information 62 indicates the product identification information described above. The generation rule 64 indicates the generation rule 40.

When the generation rule 40 is defined for each product, the acquisition unit 2020 first acquires product identification information as a rule condition. The product identification information to be acquired is, for example, product identification information that determines the target product 10 or product identification information that determines a group of products to which the target product 10 belongs. Further, the acquisition unit 2020 acquires the generation rule 40 by searching the generation rule storage apparatus 80 using the acquired product identification information. Specifically, the acquisition unit 2020 acquires the generation rule 40 indicated by the generation rule 64, from the record in which the acquired product identification information is shown in the product identification information 62. By doing so, the acquisition unit 2020 acquires the generation rule 40 corresponding to the acquired product identification information (that is, the generation rule 40 corresponding to the acquired rule condition).

There are various methods by which the acquisition unit 2020 acquires the product identification information. For example, the acquisition unit 2020 acquires the product identification information specified by the user operation. The user operation of specifying the product identification information is performed on the user terminal 100 described above, for example.

In addition, for example, the acquisition unit 2020 may acquire the product identification information of the target product 10 by a method similar to the method by which a point of sales (POS) terminal acquires the identification information of a product. Specifically, a method of reading a bar code or the like attached to the target product 10 or a method of acquiring the product identification information of the target product 10 by analyzing an image obtained by capturing the target product 10 with a camera and acquiring identification information of a product matching the target product 10 from a product database (a database that stores various types of information regarding products) can be used. Existing techniques can be used as specific techniques for realizing these methods. Note that, the identification information of the group to which the target product 10 belongs can be acquired from the product database described above, for example.

### Case Where Company is Used as Rule Condition

The method of representing the date attached to a product may differ for each company that has manufactured the product or company that sells the product. For example, it is conceivable that a date character string is attached according to the rule of “attaching the manufacturing date in the format <YYYY/MM/DD>” at the stage of being produced by the company A, “attaching the manufacturing date in the format <YYYYMM>” is required at the stage of being sold by the company B, and “attaching the expiration date in the format of <MM/DD, YYYY>” is required at the stage of being sold by the company C.

In such a case, each generation rule 40 is stored in the generation rule storage apparatus 80 in association with company identification information that identifies the company that uses the generation rule 40. For example, the company identification information indicates the name of the company, the identification number assigned to the company, or the like. Further, the company identification information is not limited to the information that identifies individual companies, and may be the information that identifies a group of companies. That is, the generation rule 40 for generating the character string 30 to be attached to the product manufactured or sold by the company belonging to the group may be associated with the group of companies. Hereinafter, information in which the generation rule 40 and the company identification information are associated with each other is referred to as rule information 70.

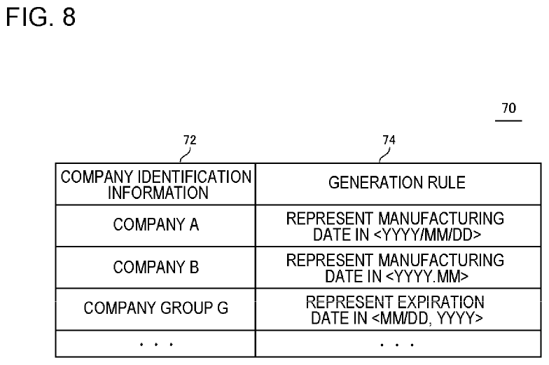

FIG. 8 is a diagram illustrating the configuration of the rule information 70 in a table format. The rule information 70 includes two fields: company identification information 72 and generation rule 74. The company identification information 72 indicates the company identification information described above. The generation rule 74 indicates the generation rule 40.

When the generation rule 40 is defined for each company, the acquisition unit 2020 first acquires company identification information as a rule condition. The company identification information to be acquired is, for example, company identification information that identifies the company that manufactures the target product 10, company identification information that identifies the company that sells the target product 10, company identification information that identifies the group to which these companies belong, or the like. Further, the acquisition unit 2020 acquires the generation rule 40 by searching the generation rule storage apparatus 80 using the acquired company identification information. Specifically, the acquisition unit 2020 acquires the generation rule 40 shown in the generation rule 74 from the record in which the acquired company identification information is shown in the company identification information 72. By doing so, the acquisition unit 2020 acquires the generation rule 40 corresponding to the acquired company identification information (that is, the generation rule 40 corresponding to the acquired rule condition).

There are various methods by which the acquisition unit 2020 acquires company identification information. For example, the acquisition unit 2020 acquires the company identification information specified by the user operation. The user operation of specifying the company identification information is performed on the user terminal 100 described above, for example.

In addition, for example, the company identification information may be stored in advance in a storage apparatus in association with the identification information of the user. The company identification information associated with the identification information of the user is, for example, the identification information of the company to which the user belongs. The method of acquiring the company identification information associated with the identification information of the user is the same as the method of acquiring the area identification information associated with the identification information of the user.

In addition, for example, the acquisition unit 2020 may determine the product corresponding to the target product 10 on a product database, and acquire the company identification information associated with the product from the database. As a method of determining the product corresponding to the target product 10 on the product database, a method of “searching the product database with the product identification information of the target product 10 obtained by reading the barcode or the like attached to the target product 10” or a method of “analyzing an image obtained by capturing the target product 10 with a camera and determining a product matching the target product 10 on the product database” can be used.

### Method of Using Plurality of Conditions

The generation rule 40 may be associated with a combination of two or more of a plurality of conditions (the above-described area identification information, product identification information, company identification information, or the like). For example, the generation rule 40 is associated with a pair of area identification information and product identification information. By doing so, the generation rule 40 can be set for each area and each product. For example, it is possible to use the generation rule 40 of “attaching the manufacturing date in the format of <YYYY/MM/DD>” for the product A to be sold in the area X, the generation rule 40 of “attaching the manufacturing date in the format of <YYYY/MM>” for the product A to be sold in the area Y, the generation rule 40 of “attaching the expiration date in the format of <YYYY/MM/DD>” for the product B to be sold in the area X, and the generation rule 40 of “attaching the expiration date in the format of <YYYY MM>” for the product B to be sold in the area Y.

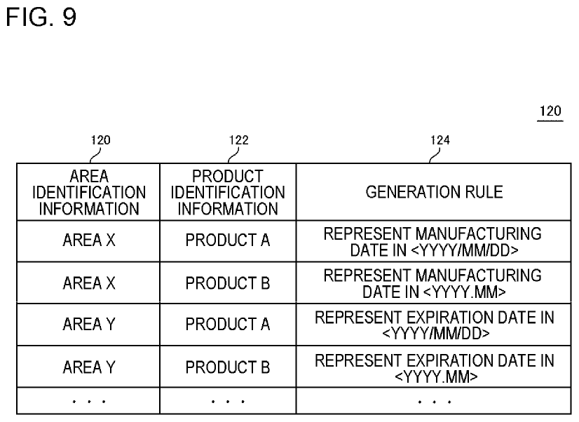

FIG. 9 is a diagram illustrating the rule information 120. The rule information 120 includes three fields: area identification information 122, product identification information 124, and generation rule 126. With such a configuration, the generation rule 126 is determined by the pair of the area identification information 122 and the product identification information 124.

When the generation rule 40 is associated with a plurality of conditions, the acquisition unit 2020 acquires a combination of a plurality of conditions as a rule condition. For example, when the generation rule 40 is associated with a pair of area identification information and product identification information, the acquisition unit 2020 acquires a pair of area identification information and product identification information as a rule condition, and acquires the generation rule 40 corresponding to the pair.

### Acquisition of Date Information 20: S104

The acquisition unit 2020 acquires the date information 20 for the target product 10 (S104). There are various methods by which the acquisition unit 2020 acquires the date information 20. For example, the acquisition unit 2020 recognizes the first date character string 12 which is the date character string already attached to the target product 10 by the character recognition process, and acquires the recognized date character string as the date information 20. More specifically, the acquisition unit 2020 acquires a date image including the first date character string 12 and performs a character recognition process on the date image. Then, the acquisition unit 2020 acquires the date character string recognized by this character recognition process as the date information 20.

The first date character string 12 represents the manufacturing date or the expiration date of the target product 10. Here, as a method of attaching a date to the target product 10, for example, a method of sticking a label with the date character string printed thereon on the target product 10 or a method of printing the date character string on the exterior of the target product 10 is used. Therefore, the date image is an image obtained by capturing an image of the label or the exterior on which the date character string is printed with a camera.

Here, the character string included in the date image acquired by the acquisition unit 2020 may be only the first date character string 12. The character string included in the date image acquired by the acquisition unit 2020 may include a character string other than the first date character string 12. In the former case, the acquisition unit 2020 handles the character string recognized from the date image as the first date character string 12. In the latter case, the acquisition unit 2020 determines the image area representing the first date character string 12 from the date image.

Various techniques can be used as a technique for determining a portion representing a desired character string from the captured image. For example, information defining a range on the date image in which the first date character string is to be included is stored in advance in a storage apparatus accessible from the acquisition unit 2020. In this case, the acquisition unit 2020 acquires the first date character string 12 by performing the character recognition process only on the range defined by the above-described information in the image area on the acquired date image.

In addition, for example, a mark whose positional relationship with the first date character string 12 is known as well as the first date character string 12 may be printed on the exterior or label of the target product 10. As the mark, any one such as a character string or a figure can be used. The acquisition unit 2020 detects a predetermined mark by performing an image analysis on the acquired date image. Then, the acquisition unit 2020 acquires the first date character string 12 by performing a character string recognition process on a character string having a predetermined positional relationship with a predetermined mark.

For example, a character string “manufacturing date:” is printed just before the first date character string 12 such as “manufacturing date: Aug. 1, 2019”. In this case, the acquisition unit 2020 performs the character recognition process on the date image to extract a series of character strings including the character string “manufacturing date:”, and acquires the first date character string 12 by removing the character string “manufacturing date:” from the extracted character string. Note that, the predetermined mark and information defining the positional relationship between the mark and the first date character string 12 are stored in advance in a storage apparatus accessible from the acquisition unit 2020.

The date image is generated, for example, by capturing the first date character string 12 with a camera provided in the user terminal 100. However, any camera is used to generate the date image and the camera is not limited to the camera provided in the user terminal 100.

There are various methods by which the acquisition unit 2020 acquires the date image. For example, it is assumed that the date generation apparatus 2000 is implemented as the server apparatus 110 described above. In this case, the acquisition unit 2020 uses the image transmitted from the user terminal 100 to the server apparatus 110 as the date image. For example, the server apparatus 110 provides the user terminal 100 with an interface (Web page or the like) for transmitting the date image to the server apparatus 110. The user terminal 100 uses this interface to transmit the date image to the server apparatus 110. The acquisition unit 2020 acquires, as a date image, the image received via this interface.

Note that, the interface for transmitting the date image to the server apparatus 110 may be provided in the user terminal 100 in advance. For example, a predetermined application for interacting with the server apparatus 110 is installed in the user terminal 100 in advance. An interface for transmitting the date image to the server apparatus 110 is included in this application. The acquisition unit 2020 acquires, as a date image, the image transmitted from the user terminal 100 to the server apparatus 110 using this interface.

Further, it is assumed that the date generation apparatus 2000 is implemented as the user terminal 100. In this case, the acquisition unit 2020 receives a user operation of specifying a date image. Then, the image specified by the user operation is used as the date image.

The first date character string 12 may be attached not to the target product 10 but to a set (lot) of a plurality of target products 10 as a processing unit. In general, products included in the same lot have the same manufacturing date and expiration date. Therefore, it is conceivable to attach the first date character string 12 to the lot, instead of attaching the first date character string 12 to each of the target products 10. Examples of the method of attaching the first date character string 12 to the lot include a method of printing the first date character string 12 on a label stuck on the exterior of the lot, or a method of printing the first date character string 12 on the exterior of the lot. When the first date character string 12 is attached to the lot, the acquisition unit 2020 recognizes the first date character string 12 attached to the lot, by using the same method as the method of recognizing the first date character string 12 attached to the target product 10.

The method of acquiring the date information 20 is not limited to the method of recognizing the first date character string 12 described above by image analysis. For example, a code (bar code, QR code (registered trademark), or the like) in which the date information 20 is coded may be attached to the target product 10. In this case, the acquisition unit 2020 acquires the date information 20 obtained by reading the code. For example, the reading of the code is performed by the user terminal 100. When the date generation apparatus 2000 is implemented as the server apparatus 110, the user terminal 100 transmits the date information 20 obtained by reading the code attached to the target product 10 to the server apparatus 110. Note that, the existing technology can be used as the technology for acquiring the coded information by reading the code.

Note that, the code described here may also be attached to the lot containing the target product 10 instead of the target product 10. The method of attaching the code to the lot is the same as the method of attaching the first date character string 12 to the lot. The method of acquiring the date information 20 from the code attached to the lot is the same as the method of acquiring the date information 20 from the code attached to the target product 10.

The date information 20 may be extractable from the identification information (lot identification information) assigned to the lot. As described above, in general, products included in the same lot have the same manufacturing date and expiration date. Therefore, the lot identification information may include information indicating the manufacturing date, the expiration date, or the like of the products included in the lot, according to a predetermined rule. Therefore, the acquisition unit 2020 acquires the lot identification information of the lot including the target product 10, and extracts the date information 20 from the lot identification information.

For example, it is assumed that lot identification information “L20190809” is assigned to a lot produced on Aug. 9, 2019. In this case, the acquisition unit 2020 can acquire the date information 20 representing the manufacturing date of the target product 10 included in the lot to which the lot identification information is assigned, by excluding the leading letter L from the lot identification information. Note that, the rule for extracting the date information 20 from the lot identification information is stored in advance in a storage apparatus accessible from the acquisition unit 2020.

The method of obtaining the date information 20 using the lot identification information is not limited to the method of extracting the date information 20 from the lot identification information. For example, the information in which the lot identification information and the date information 20 about the target product 10 included in the lot identification information are associated with each other is stored in advance in a storage apparatus accessible from the acquisition unit 2020. In this case, the acquisition unit 2020 acquires the date information 20 associated with the acquired lot identification information from the storage apparatus.

### Generation of Character String 30: S106

The generation unit 2040 uses the generation rule 40 to generate the character string 30 from the date information 20. A specific method of generating the character string 30 from the date information 20 is determined by the generation rule 40.

The generation rule 40 is a rule for generating the character string 30 from the date information 20. Here, the date character string attached to the target product 10 can be determined by a combination of the type of information represented by the date and the format of the character string. The type of information represented by the date is, for example, the manufacturing date or the expiration date. As the format of the character string, for example, various formats such as “YYYY/MM/DD”, “YYYY/MM”, “YYYY MM/DD”, and “MM/DD, YYYY”, “YYYY MM DD”, or “YYYY MM” can be adopted.

Hereinafter, first, a case where the date information 20 represents a date by a character string will be described. In this case, it is assumed that the type of information represented by the date information 20 and the type of information represented by the character string 30 are the same (for example, both represent manufacturing dates). In this case, the generation rule 40 is information that determines an algorithm (hereinafter, format conversion algorithm) for converting the format of the date. According to the format conversion algorithm, the character string 30 that represents one or more pieces of information of the year, month, and day included in the date information 20 in a predetermined format is generated.

For example, the generation rule 40 indicates the format conversion algorithm itself (that is, the program that embodies the format conversion algorithm). In addition, for example, the generation rule 40 indicates information that determines a format conversion algorithm to be used, from among a plurality of format conversion algorithms prepared in advance.

Here, the format conversion algorithm can be determined by the combination of the format of the character string of the date indicated by the date information 20 and the format of the character string 30. For example, the generation rule 40 indicates the format of the character string 30. The generation unit 2040 determines the format of the character string 30, from the acquired generation rule 40. Further, the generation unit 2040 determines the format of the date indicated by the date information 20. Then, the generation unit 2040 converts the character string of the date indicated by the date information 20 into the character string 30 by using the format conversion algorithm corresponding to the combination of determined formats.

There are various methods by which the generation unit 2040 determines the format of the date indicated by the date information 20. For example, the information indicating the format of the date indicated by the date information 20 is included in the date information 20. In addition, for example, the format of the date indicated by the date information 20 may be stored in advance in a storage apparatus accessible from the generation unit 2040.

It is assumed that the type of information represented by the date indicated by the date information 20 is different from the type of information represented by the character string 30 (for example, one represents the manufacturing date and the other represents the period of consumption). In this case, the generation unit 2040 calculates the date to be represented by the character string 30 from the date represented by the date information 20, and generates the character string 30 that represents the calculated date in a predetermined format. In this case, the generation rule 40 indicates a calculation algorithm for calculating the date to be represented by the character string 30 from the date represented by the date information 20, and the format of the date represented by the character string 30.

For example, it is assumed that the date information 20 represents the manufacturing date, and the character string 30 represents the period of consumption. In this case, the calculation algorithm is an algorithm of “adding the life of the product to the date represented by the date information 20”. On the other hand, it is assumed that the date information 20 represents the period of consumption, and the character string 30 represents the manufacturing date. In this case, the calculation algorithm is an algorithm of “subtracting the life of the product from the date represented by the date information 20”.

The generation unit 2040 calculates the date to be represented by the character string 30, from the date indicated by the date information 20, using the calculation algorithm indicated by the generation rule 40. Further, the generation unit 2040 generates, as the character string 30, a character string representing the calculated date in the format indicated by the generation rule 40.

The date information 20 may represent information on a date by data other than a character string. For example, the date information 20 represents information on a date as date-type data. In general, date-type data can be converted into a character string by specifying the format. In this case, if the type of information represented by the date indicated by the date information 20 and the type of information represented by the character string 30 are the same, the generation rule 40 indicates the format of the date represented by the character string 30. The generation unit 2040 generates the character string 30 by converting the date-type data indicated by the date information 20 into a character string of the format indicated by the generation rule 40.

Further, it is assumed that the date information 20 indicates date-type data, and the type of information represented by the date indicated by the date information 20 is different from the type of information represented by the character string 30. In this case, as in the case where the date information 20 represents the date as a character string, the generation rule 40 indicates a calculation algorithm for calculating the date to be represented by the character string 30 from the date represented by the date information 20, and the format of the date represented by the character string 30.

Note that, when the life of the target product 10 is used to calculate the character string 30, the acquisition unit 2020 further acquires information indicating the life of the target product 10 (hereinafter, lifetime information). For example, the lifetime information is stored in the product database. In this case, the acquisition unit 2020 acquires lifetime information corresponding to the target product 10 from the product database. Note that, the method of determining the product corresponding to the target product 10 on the product database is as described above.

The method of acquiring the life information is not limited to the method of acquiring the lifetime information from the product database. For example, the lifetime information may be input by the user.

### Output of Character String 30: S108

The generation unit 2040 outputs the generated character string 30 (S108). Here, the output mode of the character string 30 differs depending on usage of the character string 30. For example, as described above, the character string 30 is transmitted to the terminal (the user terminal 100 described above) operated by the worker who performs the work of attaching the second date character string 14 to the target product 10. By operating the terminal and browsing the character string 30, the worker can recognize the character string to be attached as the second date character string 14 to the target product 10.

In addition, for example, as described above, the character string 30 may be set in the printer used to attach the character string 30 to the target product 10. Specifically, the character string 30 is set as the character string to be printed by the printer. Any method is used for achieving this setting. For example, printer settings may be made by transmitting the character string 30 from the date generation apparatus 2000 to the printer. In addition, for example, the printer settings may be made by transmitting the character string 30 from the date generation apparatus 2000 to the user terminal 100 and accessing the printer from the user terminal 100.

In addition, for example, as described above, the character string 30 is used for a checking work of whether or not the second date character string 14 attached to the target product 10 is correct. In this case, the character string 30 is used in an apparatus that performs a comparison process between the second date character string 14 and the character string 30.

In addition, for example, the character string 30 may be stored in a storage apparatus such that the character string 30 can be referred to at any timing. By doing so, for example, the supervisor who finally approves the above-described repacking work can perform an approval work by browsing the character string 30 on the terminal operated by the supervisor and then visually recognizing and determining whether the generation character string 30 is correct or not.

Although the example embodiments of the present invention have been described with reference to the drawings, these are examples of the present invention, and it is possible to adopt a combination of the above respective example embodiments, or various other configurations.

Some or all of the above example embodiments may be described as in the following supplementary notes, but are not limited thereto.

1. A date generation apparatus including:
an acquisition unit that acquires date information about a target product, and a rule condition indicating a condition regarding a generation rule for generating a character string to be attached to the target product from the date information; and
a generation unit that generates the character string for the target product, using the generation rule corresponding to the acquired rule condition, from the acquired date information,
wherein the date information and the character string represent either a manufacturing date or an expiration date of the target product.

2. The date generation apparatus according to 1,
wherein area identification information, which is identification information of an area, is associated with the generation rule for generating a character string of a date to be attached to a product sold in an area corresponding to the area identification information, and
wherein the acquisition unit acquires, as the rule condition, the area identification information that identifies an area in which the target product is sold.

3. The date generation apparatus according to 1,
wherein product identification information, which is identification information of a product, is associated with the generation rule for generating a character string of a date to be attached to a product corresponding to the product identification information, and
wherein the acquisition unit acquires product identification information of the target product as the rule condition.

4. The date generation apparatus according to 1,
wherein company identification information, which is identification information of a company, is associated with the generation rule for generating a character string of a date to be attached to a product related to a company corresponding to the company identification information, and
wherein the acquisition unit acquires the company identification information of a company related to the target product as the rule condition.

5. The date generation apparatus according to any one of 1 to 4,
wherein the acquisition unit acquires lot identification information of a lot including the target product and the date information corresponding to the lot identification information, and
wherein the date information corresponding to the lot identification information is
   extracted from the lot identification information according to a predetermined rule, or
   is obtained from a storage apparatus in which the date information is stored in association with the lot identification information.

6. The date generation apparatus according to any one of 1 to 5,
wherein the date information indicates a manufacturing date of the product, and
wherein the generation rule includes a rule for converting the manufacturing date of the product represented by the date information into the expiration date of the product, based on the life of the product.

7. The date generation apparatus according to any one of 1 to 5,
wherein the date information includes one or more of year, month, and day, and
wherein the generation rule is a rule for generating the character string that represents one or more pieces of information to be attached to the target product in a predetermined format, among year, month, and day included in the date information.

8. The date generation apparatus according to any one of 1 to 7,
wherein the character string is output to a printer used to attach the character string to the target product.

9. A control method executed by a computer, including:
acquiring date information about a target product, and a rule condition indicating a condition regarding a generation rule for generating a character string to be attached to the target product from the date information; and
generating the character string for the target product, using the generation rule corresponding to the acquired rule condition, from the acquired date information,
wherein the date information and the character string represent either a manufacturing date or an expiration date of the target product.

10. The control method according to 9,
wherein area identification information, which is identification information of an area, is associated with the generation rule for generating a character string of a date to be attached to a product sold in an area corresponding to the area identification information, and
wherein the area identification information that identifies an area in which the target product is sold is acquired as the rule condition.

11. The control method according to 9,
wherein product identification information, which is identification information of a product, is associated with the generation rule for generating a character string of a date to be attached to a product corresponding to the product identification information, and
wherein the product identification information of the target product is acquired as the rule condition.

12. The control method according to 9,
wherein company identification information, which is identification information of a company, is associated with the generation rule for generating a character string of a date to be attached to a product related to a company corresponding to the company identification information, and
wherein the company identification information of a company related to the target product is acquired as the rule condition.

13. The control method according to any one of 9 to 12,
wherein lot identification information of a lot including the target product and the date information corresponding to the lot identification information is acquired, and
wherein the date information corresponding to the lot identification information is
   extracted from the lot identification information according to a predetermined rule, or
   is obtained from a storage apparatus in which the date information is stored in association with the lot identification information.

14. The control method according to any one of 9 to 13,
wherein the date information indicates a manufacturing date of the product, and
wherein the generation rule includes a rule for converting the manufacturing date of the product represented by the date information into the expiration date of the product, based on the life of the product.

15. The control method according to any one of 9 to 13,
wherein the date information includes one or more of year, month, and day, and
wherein the generation rule is a rule for generating the character string that represents one or more pieces of information to be attached to the target product in a predetermined format, among year, month, and day included in the date information.

16. The control method according to any one of 9 to 15,
wherein the character string is output to a printer used to attach the character string to the target product.

17. A program that causes a computer to execute each step of the control method according to any one of 9 to 16.

It is apparent that the present invention is not limited to the above embodiment, and may be modified and changed without departing from the scope and spirit of the invention.

What is claimed is:

1. A date generation apparatus comprising:
an acquisition unit that acquires date information about a target product, and a rule condition indicating a condition regarding a generation rule for generating a character string to be attached to the target product from the date information; and
a generation unit that generates the character string for the target product, using the generation rule corresponding to the acquired rule condition, from the acquired date information,
wherein the date information and the character string represent either a manufacturing date or an expiration date of the target product.

2. The date generation apparatus according to claim 1,
wherein area identification information, which is identification information of an area, is associated with the generation rule for generating a character string of a date to be attached to a product sold in an area corresponding to the area identification information, and
wherein the acquisition unit acquires, as the rule condition, the area identification information that identifies an area in which the target product is sold.

3. The date generation apparatus according to claim 1,
wherein product identification information, which is identification information of a product, is associated with the generation rule for generating a character string of a date to be attached to a product corresponding to the product identification information, and
wherein the acquisition unit acquires product identification information of the target product as the rule condition.

4. The date generation apparatus according to claim 1,
wherein company identification information, which is identification information of a company, is associated with the generation rule for generating a character string of a date to be attached to a product related to a company corresponding to the company identification information, and
wherein the acquisition unit acquires the company identification information of a company related to the target product as the rule condition.

5. The date generation apparatus according to claim 1,
wherein the acquisition unit acquires lot identification information of a lot including the target product and the date information corresponding to the lot identification information, and
wherein the date information corresponding to the lot identification information is
extracted from the lot identification information according to a predetermined rule, or
is obtained from a storage apparatus in which the date information is stored in association with the lot identification information.

6. The date generation apparatus according to claim 1,
wherein the date information indicates a manufacturing date of the product, and
wherein the generation rule includes a rule for converting the manufacturing date of the product represented by the date information into the expiration date of the product, based on a life of the product.

7. The date generation apparatus according to claim 1,
wherein the date information includes one or more of year, month, and day, and
wherein the generation rule is a rule for generating the character string that represents one or more pieces of information to be attached to the target product in a predetermined format, among year, month, and day included in the date information.

8. The date generation apparatus according to claim 1,
wherein the character string is output to a printer used to attach the character string to the target product.

9. A control method executed by a computer, comprising:
acquiring date information about a target product, and a rule condition indicating a condition regarding a generation rule for generating a character string to be attached to the target product from the date information; and
generating the character string for the target product, using the generation rule corresponding to the acquired rule condition, from the acquired date information,
wherein the date information and the character string represent either a manufacturing date or an expiration date of the target product.

10. A non-transitory computer readable medium storing a program that causes a computer to execute each step of a control method; the method comprising:
acquiring date information about a target product, and a rule condition indicating a condition regarding a generation rule for generating a character string to be attached to the target product from the date information; and
generating the character string for the target product, using the generation rule corresponding to the acquired rule condition, from the acquired date information,
wherein the date information and the character string represent either a manufacturing date or an expiration date of the target product.
